(19) United States
(12) Patent Application Publication
(10) Pub. No.: US 2022/0141912 A1
(43) Pub. Date: May 5, 2022

(54) Rapid Data Path Recovery in an Electronic Communications Device

(71) Applicant: Plantronics, Inc., Santa Cruz, CA (US)

(72) Inventors: Jonathan GROVER, San Jose, CA (US); Cary Arnold BRAN, Vashon, WA (US)

(21) Appl. No.: 17/090,655

(22) Filed: Nov. 5, 2020

(51) Int. Cl. H04W 76/23; H04W 76/14

(52) U.S. Cl. CPC H04W 76/23; H04W 76/14

(57) ABSTRACT

Systems and methods for recovering accidentally or unintentionally switched data paths between electronic communications devices. In some examples a data path is recovered automatically. In other examples, a user of an electronic communications device is prompted to confirm or prevent data path recovery.

### TECHNICAL FIELD

This disclosure relates generally to electronic communications devices and relates particularly to recovering a data path between two or more electronic communications devices.

### BACKGROUND

Many electronic communications devices are capable of being in signal communication with multiple external devices over multiple data paths simultaneously. There are times when such an electronic communications device must determine which data path to accommodate. Standards and protocols exist which prescribe how such determinations will be made. Sometimes, however, the determination is not what the user of the electronic communications device (ECD) would have preferred. Thus, there is room for improvement in the art.

### SUMMARY

A first example of this disclosure is a method of recovering a data path in an electronic communications device (ECD). The method includes: establishing, at a first ECD, a first channel connection with a second ECD; receiving, at the first ECD, a first data stream over the first channel connection from the second ECD; rendering, at the first ECD, first data corresponding to the first data stream; establishing, at the first ECD, a second channel connection C-2 with a third ECD; pausing, at the first ECD, the rendering of the first data, responsive to establishing the second channel connection C-2; receiving, at the first ECD, a second data stream over the second channel connection C-2 from the third ECD; rendering, at the first ECD, second data corresponding to the second data stream; rendering a prompt at the first ECD; detecting, at the first ECD, a user input corresponding to the prompt; ceasing, at the first ECD, the rendering of the second data, responsive to detecting the user input corresponding to the prompt; and resuming, at the first ECD, the rendering of the first data corresponding to the first data stream.

A second example of this disclosure is another method of recovering a data path in an ECD, in which the method includes: establishing, at a first ECD, a first channel connection with a second ECD; receiving, at the first ECD, a first data stream from the second ECD over the first channel connection; rendering, at the first ECD, first data corresponding to the first data stream, using one or more output devices of the first ECD; receiving, at the first ECD, a second data stream from a third ECD; pausing, at the first ECD, rendering of the first data, responsive to receiving the second data stream from the third ECD; rendering, at the first ECD, second data corresponding to the second data stream, using the one or more output devices of the first ECD; determining, at the first ECD, that the first data stream is currently being received from the second ECD over the first channel connection; rendering a prompt at the first ECD, responsive to determining that the first data stream is currently being received from the second ECD over the first channel connection; determining, at the first ECD, that a user input corresponding to the prompt has not been detected within a predetermined length of time since rendering the prompt; ceasing, at the first ECD, rendering of the second data, responsive to determining that the user input corresponding to the prompt has not been detected within a predetermined length of time since rendering the prompt; and resuming, at the first ECD, rendering of the first data corresponding to the first data stream.

Another example of this disclosure is an ECD that comprises: one or more transceivers; one or more output devices; one or more processors; and a memory coupled to the one or more transceivers, the one or more output devices, and the one or more processors. The memory stores instructions which are executable by the one or more processors. The instructions include instructions to: establish, using a first transceiver of the one or more transceivers, a first channel connection with a second ECD; receive, using the first transceiver, a first data stream from the second ECD over the first channel connection; render, using a first output device of the one or more output devices, first data corresponding to the first data stream; establish, using a second transceiver of the one or more transceivers, a second channel connection C-2 with a third ECD; pause, at the first output device, rendering of the first data, responsive to establishing the second channel connection C-2 with the third ECD; receive, using the second transceiver, a second data stream from the third ECD over the second channel connection C-2; render, using the first output device, second data corresponding to the second data stream; determine that the first data stream is currently being received from the second ECD; render a prompt using a second output device of the one or more output devices, responsive to determining that the first data stream is currently being received from the second ECD; determine that a user input corresponding to the prompt has not been detected within a predetermined length of time since rendering the prompt; cease rendering of the second data at the first output device, responsive to determining that the user input corresponding to the prompt has not been detected within a predetermined length of time since rendering the prompt; and resume, using the first output device, rendering of the first data corresponding to the first data stream.

### BRIEF DESCRIPTION OF THE DRAWINGS

For illustration, there are shown in the drawings certain examples described in the present disclosure. In the drawings, like numerals indicate like elements throughout. The full scope of the inventions disclosed herein is not limited to the precise arrangements and instruments shown.

FIG. 1 is a block diagram of an electronic communications device, in accordance with an example of this disclosure.

FIGS. 2A-2B illustrate electronic communications devices, in accordance with examples of this disclosure.

FIGS. 3A-3B illustrate two electronic communications devices interacting over a channel-connection, in accordance with an example of this disclosure.

FIGS. 4A-4B illustrate a process of managing one or more data paths of an electronic communications device, in accordance with an example of this disclosure.

FIGS. 5A-5B illustrate another process of managing one or more data paths of an electronic communications device.

FIGS. 6A-6B illustrate another process of managing one or more data paths of an electronic communications device.

FIG. 7 illustrates an implementation in accordance with one or more processes or methods of this disclosure.

FIG. 8 illustrates a method of recovering a data path in an electronic communications device, in accordance with an example of this disclosure.

FIG. 9 illustrates a process of recovering a data path in an electronic communications device, in accordance with an example of this disclosure.

FIG. 10 illustrates an implementation in accordance with one or more processes or methods of this disclosure.

FIG. 11 illustrates a method of recovering a data path in an electronic communications device, in accordance with an example of this disclosure.

### DETAILED DESCRIPTION

In the drawings and the description of the drawings herein, certain terminology is used for convenience only and is not to be taken as limiting the examples of the present disclosure. In the drawings and the description below, like numerals indicate like elements throughout.

As noted, there are protocols and standards which can affect how an electronic communications device (ECD) will select a data path from amongst a plurality of data paths. But sometimes the selection is not what a user desired. For example, a user might wear a headset during a teleconference at their computer, using the headset to render conference audio, when a mobile phone which is in signal communication with the headset receives a call. In some instances, the mobile device will send a data stream to the headset, and the headset will automatically begin accommodating the data stream from the mobile phone (e.g., begin ringing, emit audio from the call, etc.). Instead of hearing conference audio the headset user will hear the phone ringing, may hear audio related to the phone call, and the headset may begin sending audio captured at the headset to the mobile phone instead of to the personal computer. It is to problems such as these to which this disclosure is directed.

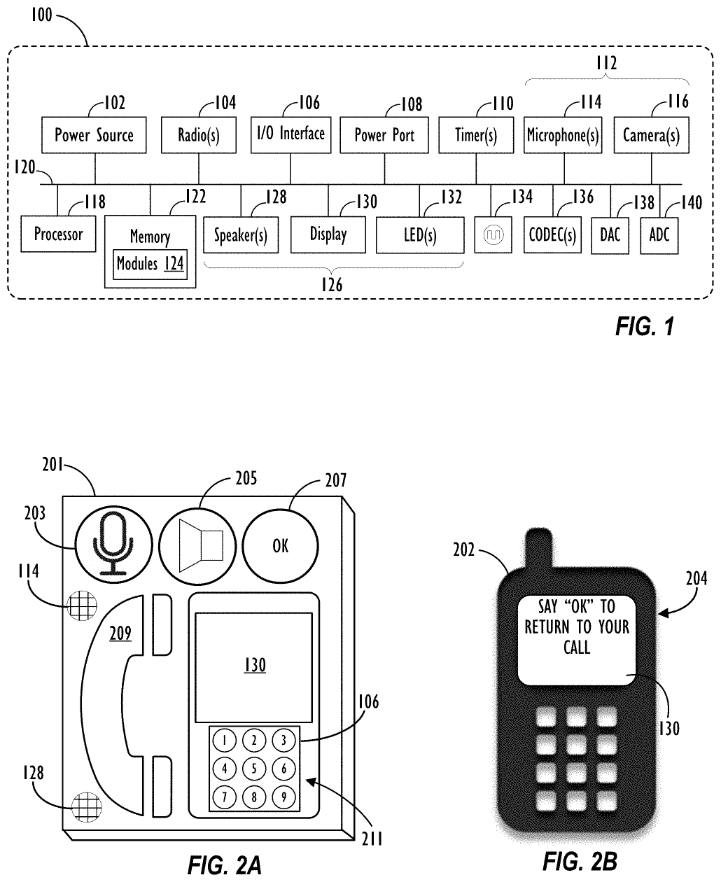

FIG. 1 is a block diagram of an electronic communications device (ECD) 100, in accordance with an example of this disclosure. The ECD 100 can include a power source 102 (e.g., a battery of rechargeable cells) and one or more radio transceivers 104 which can be used to communicate wirelessly with one or more other ECDs (e.g., headset, smart phone, computer, etc.). The ECD 100 includes one or more user interfaces 106 (e.g., capacitive sensors, actuable buttons, touchscreen, keyboard, mouse, audio detection sensors, etc.) through which a user can interact with the ECD 100. The ECD 100 can include a power port 108 which can be used to couple the internal power source 102 to an external power source (e.g., mains power) to recharge the internal power source 102. The ECD 100 can also include one or more timers 110 which can be used to track the amount of time between events and can be used in determining whether a period of time has expired, (e.g., that a user has not actuated an input after being prompted to do so). The ECD 100 can include one or more (data) capture devices 112, such as one or more microphones 114 (for capturing audio) and/or one or more cameras 116 (for capturing video). The ECD 100 also includes a processor 118 which is coupled to the power source 102, the radio transceivers 104, the user interface(s) 106, and the other components (e.g., 104-140) through a bus 120. The ECD 100 also includes a memory 122 which can store various modules 124 (of computer readable instructions) which are executable by the processor 118 to control the functions of the remaining components and their interactions with each other, as would be understood by a person of skill. In some examples, the modules (instructions) 124 comprise firmware executable by the processor 118. The ECD 100 can also include one or more (data) output devices 126 such as one or more speakers 128 (for rendering audio) and/or one or more displays 130 (for rendering video), as well as one or more light emitting diodes (LEDs) 132. The ECD 100 also includes one or more clock signal generators 134 which can be used to control the timing and synchronization of ECD 100 operations. The ECD 100 can also include one or more encoder-decoders 136 (CODECs) which the ECD 100 uses to encode data for transmission to other devices and to decode data received from other devices. The ECD 100 can also include one or more digital-to-analog converters 138 (for converting digital data to analog data for use by analog components) and one or more analog-to-digital converters 140 (for converting analog data to digital data for use by digital components). It should be recognized by those of skill in the art that the components of the ECD 100 described are illustrative, not limiting. In some examples of this disclosure, an ECD 100 will not comprise all such components. Likewise, an ECD 100 of this disclosure may include additional components. Examples of ECDs 100 within this disclosure include, but are not limited to, mobile phones, headsets, automotive transceivers, personal computers, desktop phones, laptop computers, and tablet computers, each of which can operate in accordance with one or more communications protocols (e.g., Bluetooth®, DECT™, Wi-Fi®, LTE™, 5G™).

FIG. 2A illustrates an ECD 201 (e.g., 100) which is a speakerphone, in accordance with an example of this disclosure. The speakerphone 201 includes a mute button 203, a speaker actuation button 205, and a prompt-acceptance (e.g., OK) button 207. The speakerphone 201 also includes a microphone 114, a removable handset 209, a speaker 128, a display 130, and a user interface 106 comprising a plurality of actuable keys (buttons) 211.

FIG. 2B illustrates an ECD 202 (e.g., 100) which is a mobile phone. The mobile phone 202 is displaying (rendering) a prompt 204 on a display 130.

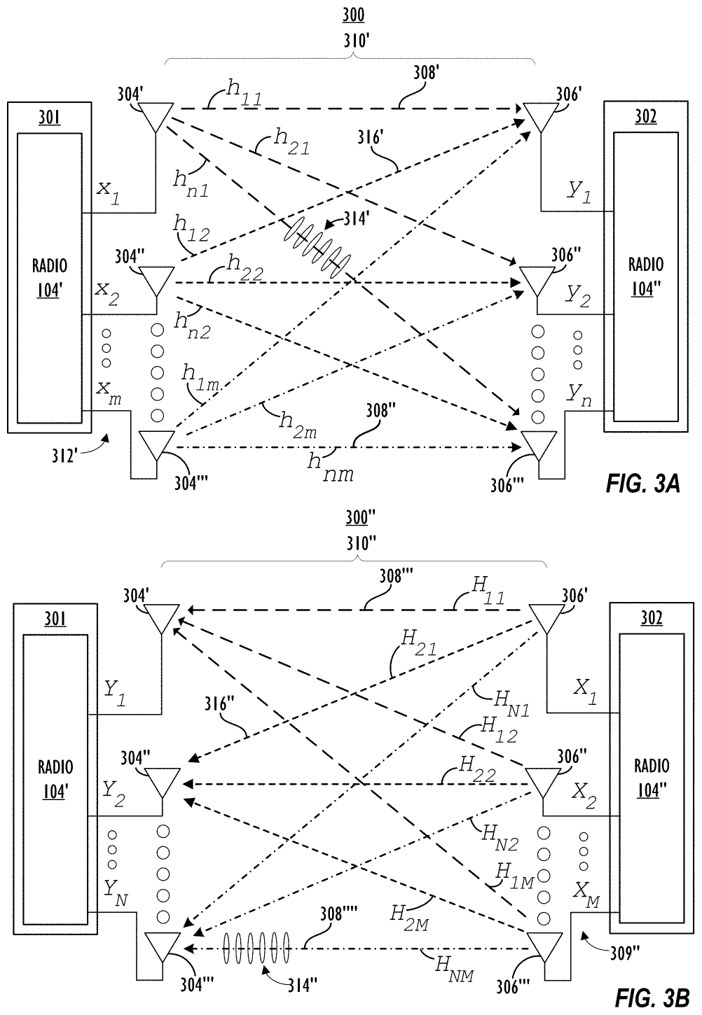

FIG. 3A illustrates an operational environment 300 of a first ECD 301 (e.g., 201) and a second ECD 302 (e.g., 202), in accordance with an example of this disclosure. Both the first ECD 301 and the second ECD 302 include at least one radio (transceiver) 104. The radio 104 of the first ECD 301 includes one or more transmit antennas 304, and the radio 104 of the second ECD 302 includes one or more receive antennas 306. In FIG. 3A, one or more data streams 308 (e.g., data paths) are transmitted over a channel connection 310 using M transmit antennas 304 of the first ECD 301 and received by N receive antennas 306 of the second ECD 302. The one or more data streams 308 are based on one or more M transmit signals 312. Each of the data streams 308 can comprise one or more data packets 314. One or more data streams 308 transmitted at a given frequency can constitute a data path (e.g., channel) 316 in one or more examples of this disclosure. Thus, a channel connection 310 can be comprised of multiple channels 316. In some examples, before a channel connection 310 can be established between two devices, an initial control channel (e.g., 316) must be established.

The ability of the first ECD 301 and the second ECD 302 to communicate the one or more data streams 308 forms the channel connection 310 between them. In accordance with one or more examples of this disclosure, when ECDs (e.g., 201, 202) are in signal communication over a channel connection 310, each ECD can be said to be in a state of ‘channel connectivity.’ Such factors as the positions of individual transmit antennas 304 and individual receive antennas 306, signal strength, and unintended coupling of individual transmit antennas 304 and individual receive antennas 306 can affect the state of the channel connection 310. It will be understood by those of skill that, as illustrated in FIG. 3B, the one or more ‘transmit’ antennas 304 of the first ECD 301 can also serve as receive antennas to receive one or more data streams 308 emitted by the antennas 306 of the second ECD 302. In at least some examples of this disclosure, an ECD (e.g., 301) can form a channel connection 310 with a second ECD (e.g., 302) only if the ECDs (e.g., 201, 202) have been paired (bonded). That is, the two devices must have shared enough information such that they will acknowledge data streams (e.g., 308) from one another and that the data streams (e.g., 308) will be transmitted in accordance with a given protocol.

In some examples of this disclosure, a given ECD (e.g., 201) can have multiple channel connections 310 with multiple other ECDs (e.g., 202). Each channel connection 310 constitutes a data path over which multiple bits of data can be continuously transmitted and received. In various examples of this disclosure, data packets 314 can include groupings of such bits of data. As will be understood by those familiar with the Bluetooth standard and other protocols, although an ECD 100 may be receiving data streams (e.g., 308) from a first ECD (e.g., 301) over a first channel connection 310, the ECD 100 can still detect signals from other devices (e.g., 201) and/or receive data streams 308 from other devices (e.g., 202).

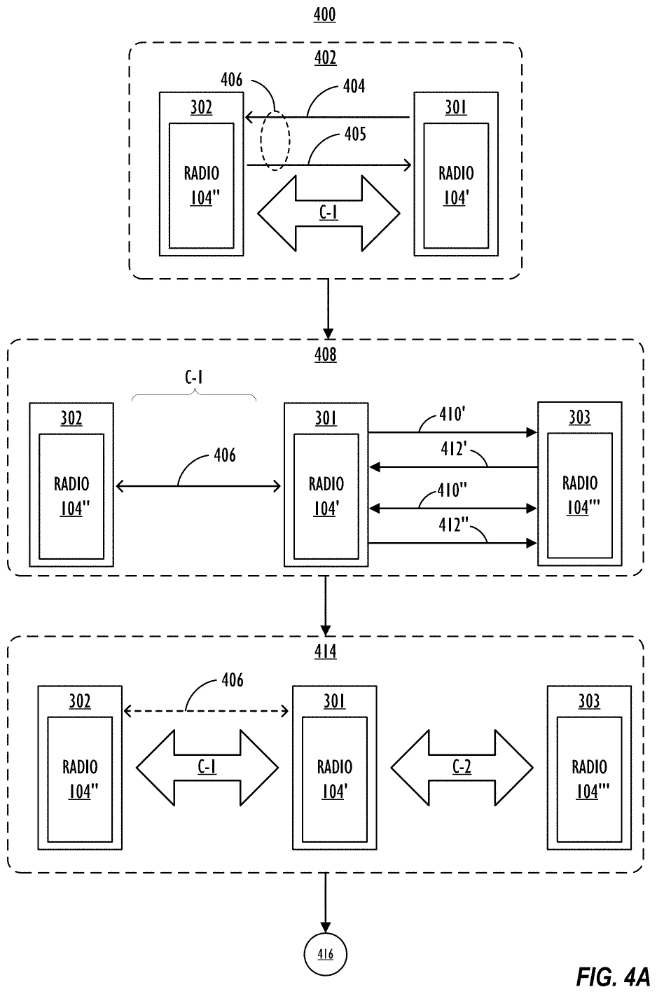

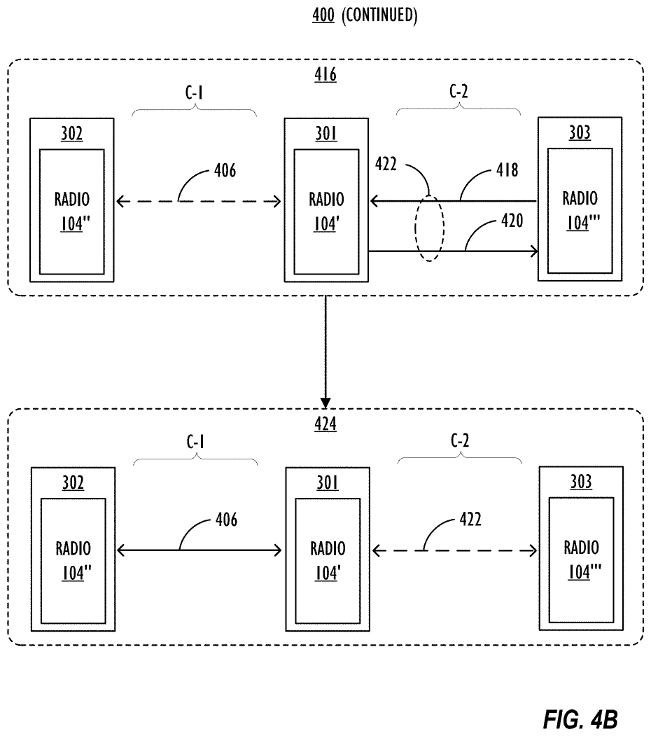

FIGS. 4A-4B illustrate a process 400 of managing one or more data paths of a first ECD 301, in accordance with an example of this disclosure. In the first step 402, the first ECD 301 (e.g., 100, 201, 202) is sending one or more data streams 404 to a second ECD 302 over a first channel connection C-1 (e.g., 310) and/or receiving one or more data streams 405 from the second ECD over the first channel connection C-1. In some examples of this disclosure, one or more of the data streams 404 and/or one or more of the data streams 405 form a data path 406. In some examples of this disclosure, the first ECD 301 renders data received from the second ECD (e.g., broadcasts audio using a speaker). Thereafter, in step 408, the first ECD 301 forms (establishes) a second channel connection C-2 (see step 414) with a third ECD 303. The second channel connection C-2 can be established as a result of the first ECD 301 sending a channel-initiation signal 410 to the third ECD 303 and/or receiving a channel acceptance signal 412 in response. In some examples, the second channel connection C-2 can be formed as a result of the first ECD's receiving a channel initiation signal 410 from the third ECD 303 and/or sending a channel acceptance signal 412 to the third ECD 303.

In step 414, the second channel connection C-2 has been formed, and as a result, the first ECD 301, at least temporarily, stops rendering the data it is receiving from the second ECD through data path 406. In some examples, the first ECD 301 also stops transmitting data to the second ECD 302 through data path 406. In step 416, the first ECD 301 receives one or more data streams 418 from the third ECD 303 and/or transmits one or more data streams 420 to the third ECD 303. In one or more examples, the one or more data streams 418 received from the third ECD 303 and/or the one or more data streams 420 sent to the third ECD 303 comprise a (second) data path 422. In at least one example, the first ECD 301 will render data (e.g., playing video using a display 130) received from the third ECD 303 over the second channel connection C-2.

In step 424, the first ECD 301 determines (using, e.g., a processor 118) that data is still being detected/received from the second ECD 302, and so returns to rendering data being received from the second ECD 302 through data path 406. In other words, data path 406 has been recovered.

In at least some examples, the first ECD 301 will notify a user before recovering data path 406. In some examples, the notification can be in the form of verbal audio. For example, the first ECD 301 could emit audio such as, “Your car (e.g., third ECD 303) has taken over the call (data path 406)—we are switching the audio back to your headset.” In some examples, the first ECD 301 and/or the second ECD 302 can produce tonal audio, for example four tones then a beep, or some other user-specified tone setting. In some examples, the first ECD 301 and/or the second ECD 302 can display a visual notification (e.g., using a display 130). In accordance with some examples, the user will be prompted to enter some type of user input if the user does not want to reestablish the first data path 406. Such prompting can take the form of spoken audio from the first ECD 301 and/or the second ECD 302, such as “Your car (third ECD 303) has taken over the call (data path 406)—we are switching the audio back to your headset (second ECD 302) now, say IGNORE if you don't want the audio switched back.” Alternately or additionally, the user can be prompted to press a button 211 (or touch screen) of the first ECD 301 and/or the second ECD 302, and/or to say a particular word into a microphone 114 of the first ECD 301 and/or the second ECD 302. If the second ECD 302 is a headset, the user might be able to indicate that they do not want data path 406 to be reestablished by removing the headset from their head.

In some examples, if a designated user input is not detected at the first ECD 301, then the first ECD 301 will reestablish data path 406 as described with respect to step 424. In some examples, once the reestablishment of data path 406 has occurred as in step 424, the second ECD 302 will provide a further notification for the user. For example, the second ECD 302 might emit audio such as “Audio-successfully re-routed.” In some examples no such notification is provided because the user is able to infer the reestablishment of the data path 406 insofar as the user is (once again) able to see and/or hear the audio-visual data streamed from the second ECD 302 to the first ECD 301. In some examples, if data path 422 was initiated because the third ECD 303 was placed in signal communication with a fourth device or remote endpoint (not shown), the fourth device or person at the remote endpoint will receive a notice that data path 422 will be terminated. In some examples, when the rendering of data of data path 406 is paused, if the second ECD 302 was in signal communication with a fifth device or a person at an endpoint (not shown) (e.g., the second ECD 302 was connecting the fifth device to the first ECD 301), the fifth device or person at the endpoint will receive a notification.

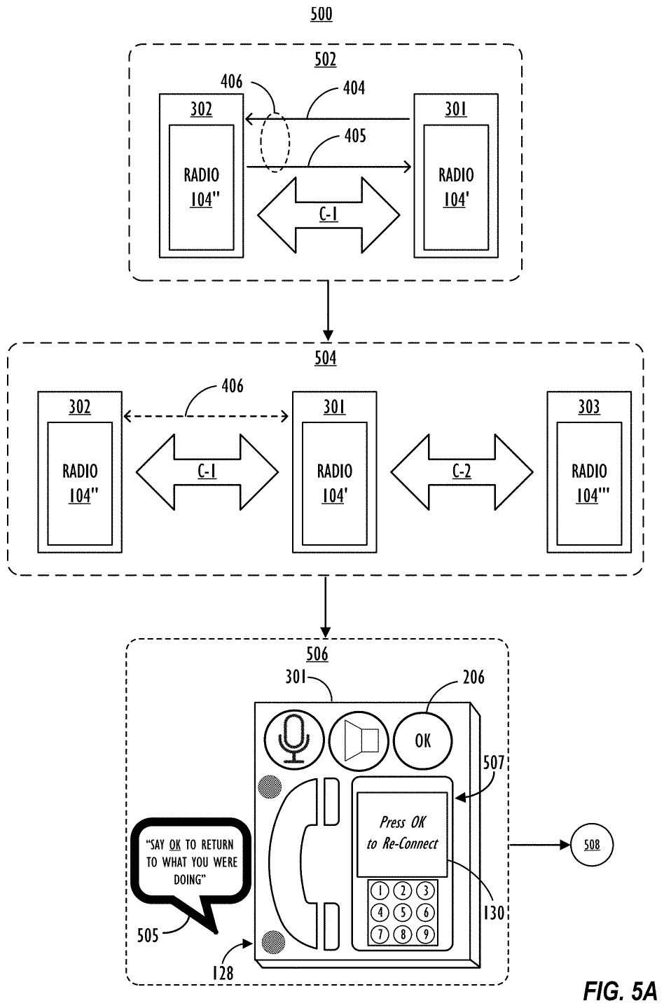

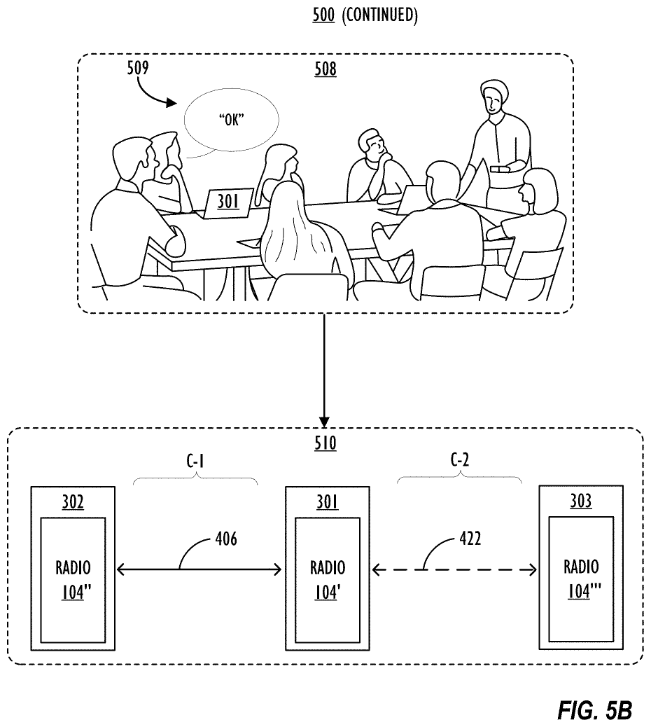

FIGS. 5A-5B illustrate a process 500 of managing one or more data paths of a first ECD 301, in accordance with an example of this disclosure. In the first step 502, the first ECD 301 (e.g., 100, 201, 202) is sending one or more data streams 404 to a second ECD 302 over a first channel connection C-1 (e.g., 310) and/or receiving one or more data streams 405 from the second ECD 302 over the first channel connection C-1. In some examples of this disclosure, one or more of the data streams 404 form a data path 406. In some examples of this disclosure, the first ECD 301 renders data received from the second ECD 302 (e.g., plays audio using a speaker). Thereafter, in step 504, the first ECD 301 forms (establishes) a second channel connection C-2 (see step 414) with a third ECD 303. The second channel connection C-2 can be established as a result of the first ECD's sending a channel-initiation signal (see FIG. 4A) to the third ECD 303 and/or receiving a channel acceptance signal (see FIG. 4A) in response. In some examples, the second channel connection C-2 can be formed as a result of the first ECD's receiving a channel initiation signal (see FIG. 4A) from the third ECD 303 and/or sending a channel acceptance signal (see FIG. 4A) to the third ECD 303. In some examples, once the second channel connection C-2 has been formed, the first ECD 301 pauses rendering the data it is receiving from the second ECD 302 (through data path 406). In some examples, the first ECD 301 also stops transmitting data to the second ECD 302 through data path 406. In some examples, once the second channel connection C-2 is established, the first ECD 301 receives one or more data streams (see FIG. 4B) from the third ECD 303 and/or transmits one or more data streams (see FIG. 4B) over the second channel connection C-2.

In step 506, the first ECD 301 renders a prompt for a user to take an action. The prompt can be in the form of an audio message 605 rendered by one or more speakers 128 and/or a visual message 507 rendered by a display 130. In step 508, the user enters an input 509 as prompted, so the first ECD 301 returns to rendering data received from the second ECD 302 over data path 406 and/or returns to transmitting data to the second ECD 302 over data path 406. In some examples, the first ECD 301 stops, at least temporarily, rendering data received over data path 422 from the third ECD 303. In some examples, the first ECD 301 terminates the second channel connection C-2. In some examples, the first ECD 301 also becomes unbonded from the third device.

In one or more examples, the one or more data streams 418 received from the third ECD 303 and/or the one or more data streams 420 sent to the third ECD 303 comprise a (second) data path 422. In at least one example, the first ECD 301 will render data (e.g., playing video using a display 130) received from the third ECD 303 (over the second channel connection C-2).

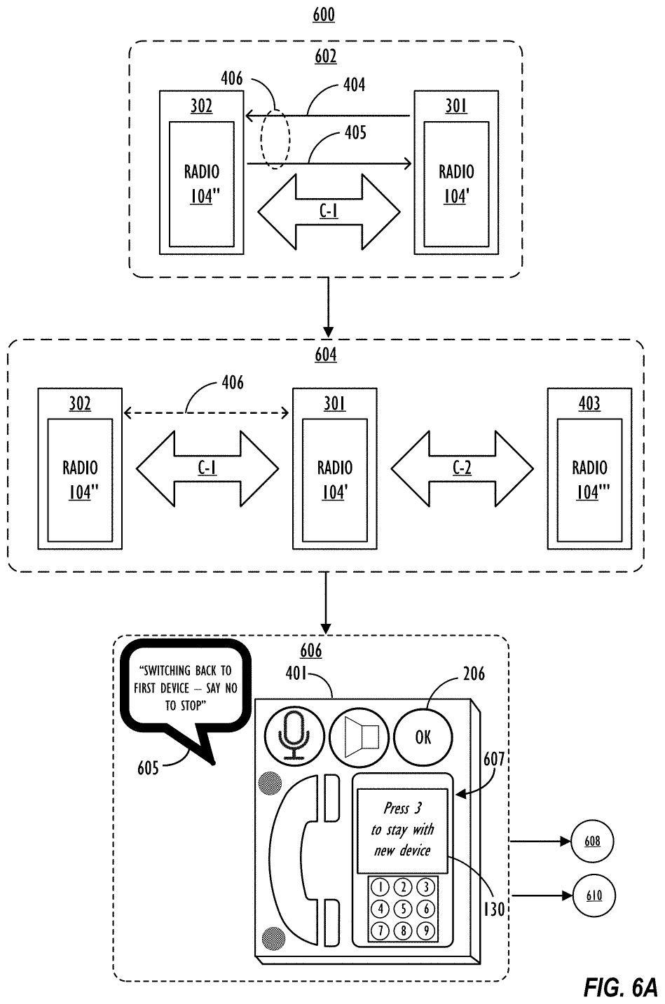

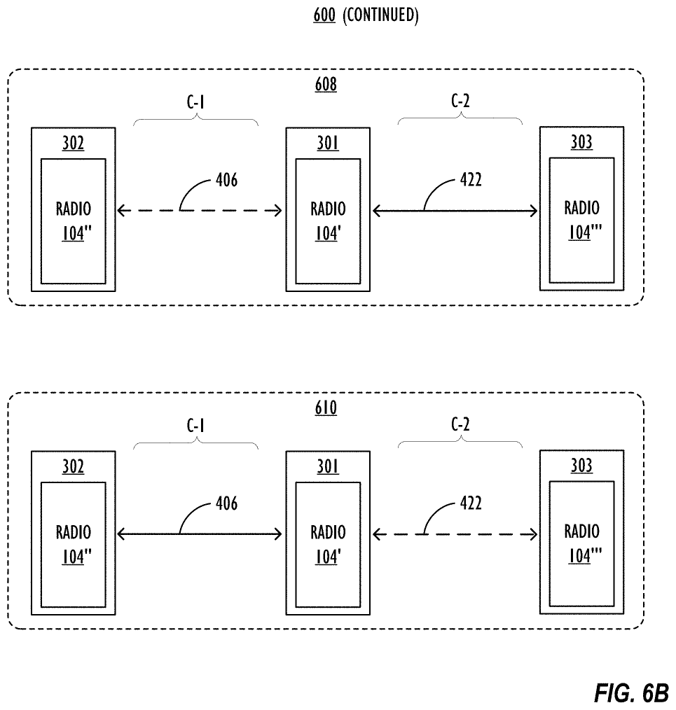

FIGS. 6A-6B illustrate another process 600 of managing one or more data paths of a first ECD 301, in accordance with an example of this disclosure. In the first step 602, the first ECD 301 (e.g., 100, 201, 202) is sending one or more data streams 404 to a second ECD 302 over a first channel connection C-1 (e.g., 310) and/or receiving one or more data streams 405 from the second ECD 302 over the first channel connection C-1. Thereafter, in step 604, the first ECD 301 forms (establishes) a second channel C-2 with a third ECD 303. The second channel connection C-2 can be established as a result of the first ECD 301 sending a channel-initiation signal (see FIG. 4A) to the third ECD 303 and/or receiving a channel acceptance signal (see FIG. 4A) in response. In some examples, the second channel connection C-2 can be formed as a result of the first ECD's receiving a channel initiation signal (see FIG. 4A) from the third ECD 303 and/or sending a channel acceptance signal (see FIG. 4A) to the third ECD 303. In some examples, once the second channel connection C-2 has been formed, the first ECD 301 pauses rendering the data it is receiving from the second ECD 302 through data path 406. In some examples, the first ECD 301 also stops transmitting data to the second ECD 302 through data path 406.

In some examples, once the second channel connection C-2 is established in step 604, the first ECD 301 receives one or more data streams (see FIG. 4B) from the third ECD 303 and/or transmits one or more data streams (see FIG. 4B) to the third ECD 303 over the second channel connection C-2. In at least one example, the first ECD 301 will render data (e.g., playing music using one or more speakers 128) received from the third ECD 303 (over the second channel connection C-2).

In step 606, the first ECD 301 renders a prompt for a user to prevent the first ECD 301 from returning to accessing the data path 406 with the second ECD 302. The prompt can be in the form of an audio message 505 rendered by one or more speakers 128 and/or a visual message 607 rendered by a display 130. If the user enters an appropriate input in response to the prompt, the first ECD 301 will continue to access data path 422, as shown in step 608. In at least one example, the first ECD 301 will render data (e.g., playing video using a display 130) received from the third ECD 303 over the second channel connection C-2.

On the other hand, if a predetermined length of time elapses during which the user does not respond to the prompt, the first ECD 301 will return to accommodating the data of the first data path 406, as shown in step 610. In step 610, accommodating data path 406 can include rendering data received from the second ECD 302 over data path 406 and/or transmitting data to the second ECD 302 over data path 406.

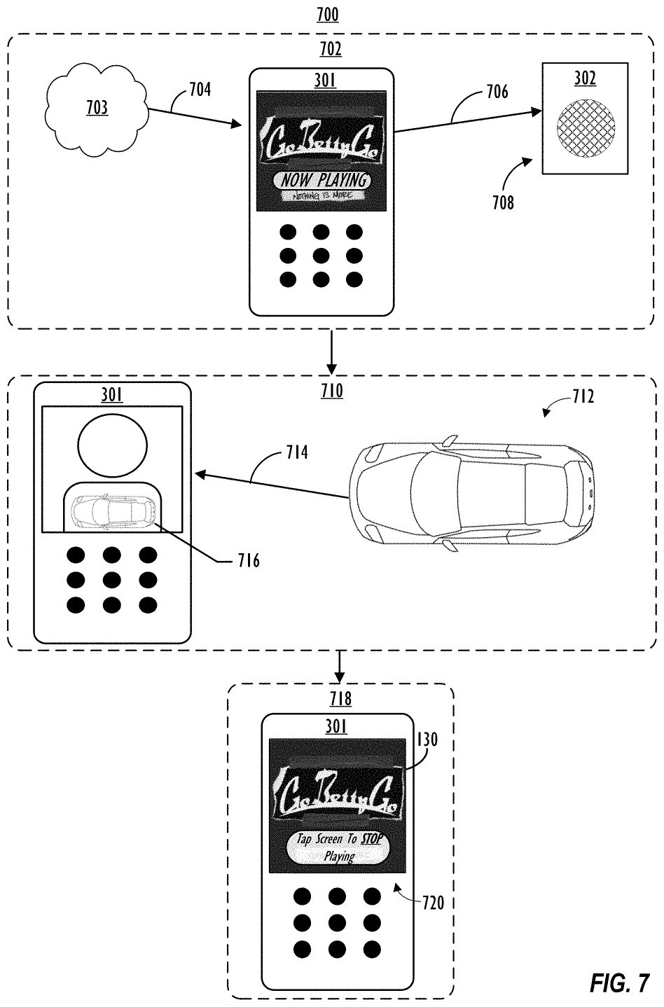

FIG. 7 illustrates an implementation 700 of process 600, in accordance with an example of this disclosure. At a first time 702, ECD 301 is streaming 704 data from the cloud 703 and transmitting 706 the streamed data to a second ECD 302, which is a smart speaker 708. At a second time 710, a car parks nearby. The car's (radio) transceiver was previously bonded (paired) with the first ECD 301. The car's transceiver couples to the first ECD 301 and begins transmitting data over data path 714. The first ECD 301 displays a notification 716 indicating that the car's transceiver and the first ECD 301 are in signal communication. At time 718, the first ECD 301 displays a visual prompt 720. In this implementation 700, the first ECD 301 will continue to stream 704 and transmit 706 data from the cloud 703 unless the user taps the display 130. In some examples, if the user does not tap the display 130, the first ECD 301 will capture data (e.g., audio) and transmit the data to the transceiver of the car 712. In some examples, if the user does not tap the display, the first ECD 301 will render data received from the car's radio (or even from another device coupled to the car's radio).

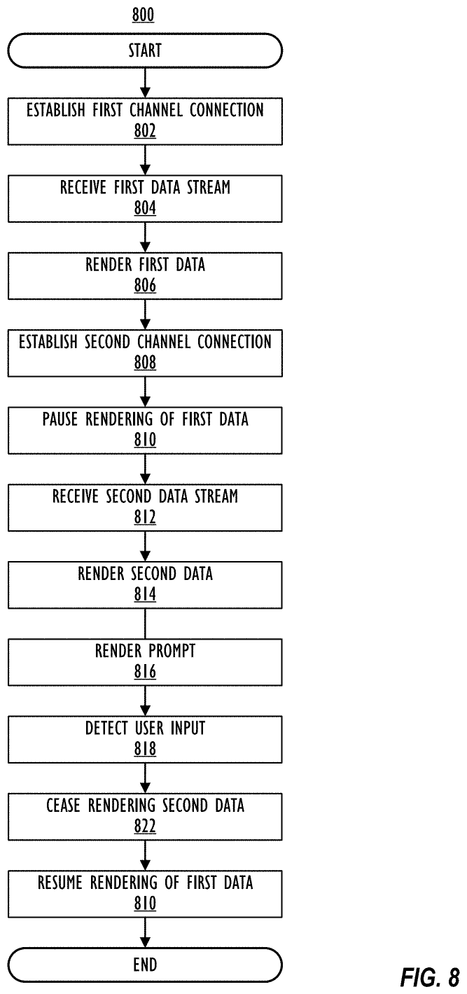

FIG. 8 illustrates a method of recovering a data path in an ECD. At step 802, a first ECD 301 establishes a first channel connection C-1 with a second ECD 302. At step 804, the first ECD 301 receives a first data stream from the second ECD 302 over the first channel connection C-1. At step 806, the first ECD 301 renders data from the first data stream, (e.g., using the one or more output devices 126). Thereafter, in step 808, the first ECD 301 establishes a second channel connection C-2 with a third ECD 303, and as a consequence, in step 810, the first ECD 301 pauses rendering of the data of the first data stream.

In step 812, the first ECD 301 receives a second data stream from the third ECD 303 and in step 814, the first ECD 301 renders data corresponding thereto (e.g., using the one or more output devices 126). In step 816, the first ECD 301 renders a prompt for a user to enter an input or take some action. At step 818, the first ECD 301 detects a user input corresponding to the prompt, so in step 820 the first ECD 301 stops rendering the data coming from the third ECD 303. In step 822, the first ECD 301 returns to rendering data coming from the second ECD 302.

In at least one example of this disclosure, the method 800 further includes transmitting a channel-initiation signal from the first ECD 301 to the third ECD 303 and receiving a channel-acceptance signal from the third ECD 303. In some examples, establishing 808 the second channel connection C-2 with the third ECD 303 occurs in response to the first ECD's receiving the channel-acceptance signal. In accordance with other examples, the first ECD 301 receives the channel-initiation signal from the third ECD 303 and transmits a channel-acceptance signal to the third ECD 303 in reply, after which the first ECD 301 establishes the second channel connection C-2.

In one or more examples of this disclosure, the method 800 also includes: capturing audio-visual data using one or more capture devices of the first ECD 301; transmitting, a third data stream to the second ECD 302, where the third data stream corresponds to the audio-visual data; pausing, at the first ECD 301, the transmission of the third data stream to the second ECD 302, responsive to establishing the second channel connection C-2; and thereafter—in response to detecting 818 the indicated user input—resuming transmission of the third data stream to the second ECD 302.

In some examples of method 800, pausing transmission of the third data stream to the second ECD 302 comprises transmitting a fourth data stream to the third ECD 303, with the fourth data stream corresponding to the (captured) audio-visual data. In at least one example, transmitting the third data stream to the second ECD 302 comprises ceasing transmission of the fourth data stream (to the third ECD 303). In at least one example, capturing the audio-visual data using one or more capture devices 112 of the first ECD 301 includes capturing audio data using a microphone 114 of the first ECD 301 and capturing video data using a camera 116 of the first ECD 301.

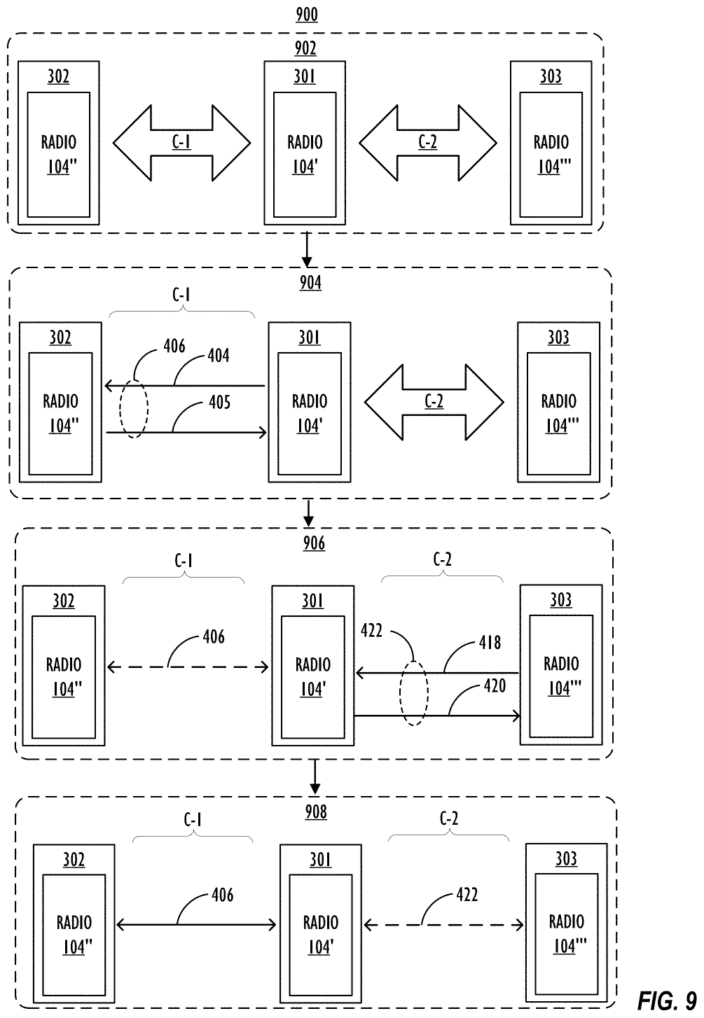

FIG. 9 illustrates a process 900 of managing data streams at a first ECD 301. In step 902, the first ECD 301 has a first channel connection C-1 with a second ECD 302 and a second channel connection C-2 with a third ECD 303. At step 904, the first ECD 301 communicates over data path 406 with ECD 302, which can include sending data streams 404 to the second ECD 302 and/or receiving data streams 405 from the second ECD 302 over data path 406 of channel connection C-1. Additionally, the first ECD 301 may render data received over data path 406. Thereafter, in step 906, the first ECD 301 receives a third data stream 418 from the third ECD 303 over data path 422 of channel connection C-2, and so pauses rendering data of data path 406. At step 908 however, the first ECD 301 determines that data of data path 406 is still being detected, and so the first ECD 301 stops, at least temporarily, rendering data received over data path 422, and returns to rendering data of data path 406. In some examples, returning to data path 406 happens automatically. In some examples, returning to data path 406 does not occur unless a user enters a specified input in response to a prompt (see FIG. 5B). In some examples, unless the user enters such an input, the ECD 301 will simply continue to render data received over data path 422 (see 606-608, FIGS. 6A-6B).

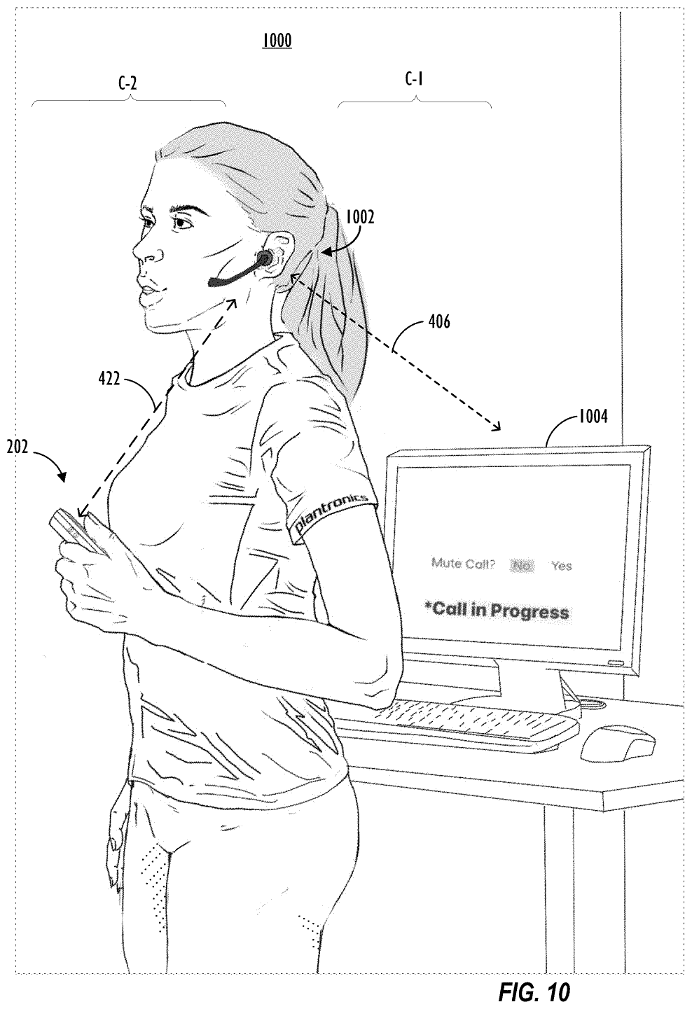

FIG. 10 illustrates a user during a teleconference. The user has a headset 1002, a computer 1004, and a mobile phone 202. The headset 1002 is coupled with the computer 1004 over a first channel connection C-1. The headset 1002 is also coupled to the mobile phone 202 over a second channel connection C-2. Audio of the teleconference is being streamed between the user's headset 1002 (e.g. first ECD 301) and her desktop computer 1004 (e.g., second ECD 302) over a first data path 406. During her teleconference, the user receives a phone call on her mobile phone 202 (e.g., ECD 303). The mobile phone 202 initiates a second data path 422 with the headset 1002, interrupting her teleconference. In some examples, the headset 1002 will indicate to the user that if she does not take some action (e.g., saying “accept phone call”) the headset 1002 will stop rendering data from the second data path 422 and return to streaming audio over data path 406. In other examples, the headset 1002 will render an (audible) indication that if she wants to return to streaming audio over data path 406, she should say “return.” If she does not say “return,” the headset 1002 will continue with the call over data path 422.

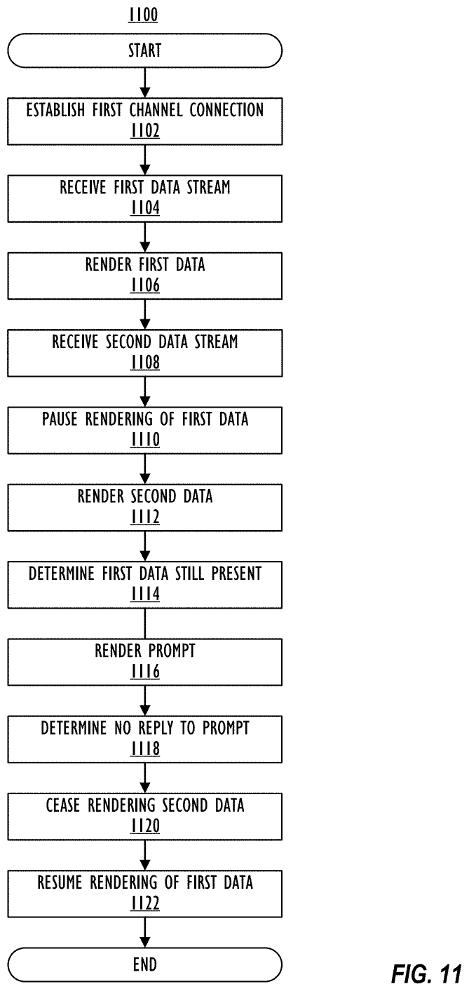

FIG. 11 illustrates a method 1100 of recovering a data path in an ECD. In step 1102, a first ECD (e.g., 301) establishes a first channel connection C-1 with a second ECD (e.g., 302). At step 1104, the first ECD 301 receives a first data stream from the second ECD 302 over the first channel connection C-1. At step 1106, the first ECD 301 renders first data corresponding to the first data stream, (e.g., using one or more output devices). At step 1108, the first ECD 301 receives a second data stream from a third ECD 303. At step 1110, the first ECD 301 pauses rendering of the first data in response to receiving the second data stream from the third ECD 303. At step 1112, the first ECD 301 renders data corresponding to the second data stream. At step 1114, the first ECD 301 determines that data is still being received from the second ECD 302, and so in step 1116, the first ECD 301 renders a prompt (e.g., displays a notification on a display 130) At step 1118, the first ECD 301 determines that a user input corresponding to the prompt has not been detected within a predetermined length of time (since rendering the prompt), so in step 1120, the first ECD 301 ceases, (at least for the moment) rendering data coming from the third ECD 303. In step 1122, the first ECD 301 resumes (or continues) rendering data of the first data stream.

In one or more examples of method 1100, receiving 1108 the second data stream from the third ECD 303 comprises establishing a second channel connection C-2 with the third ECD 303. In some examples, ceasing rendering of the second data comprises terminating the second channel connection C-2 with the third ECD 303. In at least one example terminating the second channel connection C-2 with the third ECD 303 comprises unbonding the first ECD 301 from the third ECD 303.

In some examples of the method 1100, rendering 1116 a prompt at the first ECD 301 comprises emitting an audio notification 408 using a speaker 128 of the first ECD 301. In some examples, rendering the prompt also includes displaying a visual notification 507 using a display 130 of the first ECD 301. In at least one example, rendering a prompt at the first ECD 301 further comprises activating one or more light emitting diodes 132.

In accordance with some examples of the method 1100, pausing, at the first ECD 301, rendering of the first data further comprises sending a streaming-pause signal to the second ECD 302 which is adapted to notify (a user of) the second ECD 302 that rendering of the first data has been paused. In some examples, ceasing rendering of the second data comprises sending a streaming-cessation signal to the third ECD 303 to notify (a user of) the third ECD 303 that rendering of the second data has—at least temporarily—ceased.

Examples of this disclosure also include the following examples:

1. An ECD 100, comprising: one or more transceivers 104; one or more output devices 126; one or more processors 118; and a memory 122 coupled to the one or more transceivers 104, the one or more output devices, and the one or more processors, the memory storing instructions executable by the one or more processors, the instructions comprising instructions to: establish, using a first transceiver of the one or more transceivers 104, a first channel connection C-1 with a second ECD 302; receive, using the first transceiver, a first data stream from the second ECD 302 over the first channel connection C-1; render, using a first output device of the one or more output devices, first data corresponding to the first data stream; establish, using a second transceiver of the one or more transceivers 104, a second channel connection C-2 with a third ECD 303; pause, at the first output device, rendering of the first data, responsive to establishing the second channel connection C-2 with the third ECD 303; receive, using the second transceiver, a second data stream from the third ECD 303 over the second channel connection C-2; render, using the first output device, second data corresponding to the second data stream; determine that the first data stream is currently being received from the second ECD 302; render a prompt using a second output device of the one or more output devices, responsive to determining that the first data stream is currently being received from the second ECD 302; determine that a user input corresponding to the prompt has not been detected within a predetermined length of time since rendering the prompt; cease rendering of the second data at the first output device, responsive to determining that the user input corresponding to the prompt has not been detected within a predetermined length of time since rendering the prompt; and resume, using the first output device, rendering of the first data corresponding to the first data stream.

2. The ECD of example 1, wherein the first transceiver is different from the second transceiver.

3. The ECD of example 1, wherein the instructions further comprise instructions to: transmit, using the first transceiver, a streaming-pause signal 312 to the second ECD 302, responsive to establishing the second channel connection C-2 with the third ECD 303, the streaming-pause signal 312 adapted to notify the second ECD 302 that rendering of the first data has been paused.

4. The ECD of example 1, wherein: the one or more output devices comprise a speaker 128 and a display 130; the instructions to render, using the first output device, the second data corresponding to the second data stream comprise instructions to render, using the speaker, audio data corresponding to the second data stream; and the instructions to render the prompt using the second output device comprise instructions to display the prompt using the display

5. The ECD of example 4, wherein the instructions to render, using the speaker, the audio data corresponding to the second data stream comprise instructions to render, using the display, visual data corresponding to the second data stream.

6. A non-transitory computer readable medium storing instructions executable by a processor 118 of a first ECD 301, wherein the instructions comprise instructions to: establish, using a first transceiver 104 of the first ECD 301, a first channel connection C-1 with a second ECD 302; establish, using a second transceiver of the first ECD 301, a second channel connection C-2 with a third ECD 303; receive, using the first transceiver, a first data stream from the second ECD 302 over the first channel connection C-1; render, using an output device of the first ECD 301, first data corresponding to the first data stream; detect, using the second transceiver, a second data stream from the third ECD 303 over the second channel connection C-2; pause rendering of the first data, responsive to detecting the second data stream; render, using the output device, second data corresponding to the second data stream; determine that the first data stream is currently being received from the second ECD 302 over the first channel connection C-1; pause rendering of the second data, responsive to determining that the first data stream is currently being received from the second ECD 302 over the first channel connection C-1; and resume rendering of the first data corresponding to the first data stream

7. The non-transitory computer readable instructions of example 6, wherein the instructions further comprise instructions to: transmit, using the first transceiver, a streaming-pause signal 312 to the second ECD 302, responsive to detecting the second data stream, the streaming-pause signal 312 adapted to notify the second ECD 302 that rendering of the first data has been paused

8. The non-transitory computer readable instructions of example 6, wherein the instructions further comprise instructions to: transmit, using the first transceiver, a streaming-pause signal 312 to the third ECD 303, responsive to determining that the first data stream is currently being received from the second ECD 302 over the first channel connection C-1, the streaming-pause signal 312 adapted to notify the third ECD 303 that rendering of the second data has been paused.

9. A method of rapidly recovering a data path at an electronic communications device (ECD) 100, comprising: establishing, by a first ECD 301, a first data path 406 with a second ECD 302; detecting, by the first ECD 301, a data path 316 initiation signal from a third ECD 303; terminating, by the first ECD 301, the first data path 406 with the second ECD 302 and establishing a second data path 422 with the third ECD 303, responsive to detecting the data path 316 initiation signal; rendering, at the first ECD 301, an indication that the second data path 422 will be terminated, and that the first data path 406 will be reestablished; terminating, by the first ECD 301, the second data path 422; and reestablishing, by the first ECD 301, the first data path 406 with the second ECD 302.

10. The method of example 9, further comprising: rendering, using the first ECD 301, an indication to prompt a user to enter a designated user input within a predetermined amount of time; and determining, at the first ECD 301, that the designated user input has not been detected within the predetermined amount of time; and wherein terminating, by the first ECD 301, the second data path 422 comprises terminating the second data path 422 responsive to determining, at the first ECD 301, that the designated user input has not been detected within the predetermined amount of time, and wherein reestablishing, by the first ECD 301, the first data path 406 with the second ECD 302, comprises reestablishing the first data path 406 responsive to termination the second data path 422.

11. The method of example 10, wherein rendering, using the first ECD 301, the indication to prompt the user to enter the designated user input within the predetermined amount of time comprises displaying a prompt on a display 130 of the first ECD 301.

12. The method of example 10, wherein rendering, using the first ECD 301, the indication to prompt the user to enter the designated user input within the predetermined amount of time comprises rendering a voice message.

13. The method of example 10, wherein rendering, using the first ECD 301, the indication to prompt the user to enter the designated user input within the predetermined amount of time comprises rendering one or more audio tones.

14. The method of example 9, further comprising: transmitting, by the first ECD 301, a control signal to the second ECD 302 operable to cause the second ECD 302 to rendering, at the first ECD 301, an indication that the second data path 422 will be terminated, and that the first data path 406 will be reestablished, absent a designated user action.

15. The method of example 14, wherein the second ECD 302 is a headset and the designated user action is removal of the headset from a user's head.

16. An electronic communications device (ECD) 100, comprising: a processor 118; and a memory 122, the memory 122 storing instructions 124 executable by the processor 118, wherein the instructions 124 comprise instructions 124 to: establish, using a radio 104, a first data path 406 with a second ECD 302; detect, using the radio 104, a data path 316 initiation signal from a third ECD 303; terminate the first data path 406 with the second ECD 302 and establish a second data path 422 with the third ECD 303, responsive to detecting the data path 316 initiation signal; render, an indication that the second data path 422 will be terminated, and that the first data path 406 will be reestablished; terminate the second data path 422; and reestablish the first data path 406 with the second ECD 302.

17. The ECD 100 of example 16, wherein the instructions 124 further comprise instructions 124 to: render an indication to prompt a user to enter a designated user input within a predetermined amount of time; and determine when the designated user input has not been detected within the predetermined amount of time; and wherein the instructions 124 to terminate the second data path 422 comprise instructions 124 to terminate the second data path 422 responsive to determining when the designated user input has not been detected within the predetermined amount of time, and wherein the instructions 124 to reestablish the first data path 406 with the second ECD 302, comprises instructions 124 to reestablish the first data path 406 responsive to termination the second data path 422.

18. The ECD 100 of example 17, wherein the instructions 124 to render the indication to prompt the user to enter the designated user input within the predetermined amount of time comprise instructions 124 to display a prompt on a display 130 of the ECD 300.

19. The ECD 100 of example 17, wherein the instructions 124 to render the indication to prompt the user to enter the designated user input within the predetermined amount of time comprise instructions 124 to render a voice message.

20. The ECD 100 of example 17, wherein the instructions 124 to render 816, 1116 the indication to prompt the user to enter the designated user input within the predetermined amount of time comprise instructions 124 to emit one or more audio tones.

21. The ECD 100 of example 16, wherein the instructions 124 further comprise instructions 124 to:

transmit a control signal to the second ECD 302 operable to cause the second ECD 302 to render 816, 1116, at the second ECD 302, an indication that the second data path 422 will be terminated, and that the first data path 406 will be reestablished, absent a designated user action.

22. A non-transitory computer readable medium storing instructions 124 executable by a processor 118 of a first electronic communications device (ECD) 301, wherein the instructions 124 comprise instructions 124 to: establish, using a radio 104, a first data path 406 with a second ECD 302; detect, using the radio 104, a data path 316 initiation signal from a third ECD 303; terminate the first data path 406 with the second ECD 302 and establish a second data path 422 with the third ECD 303, responsive to detecting the data path 316 initiation signal; render 816, 1116, an indication that the second data path 422 will be terminated, and that the first data path 406 will be reestablished; terminate the second data path 422; and reestablish the first data path 406 with the second ECD 302.

23. The non-transitory computer readable medium of example 22, wherein the instructions 124 further comprise instructions 124 to: render 816, 1116 an indication to prompt a user to enter a designated user input within a predetermined amount of time; and determine when the designated user input has not been detected within the predetermined amount of time; and wherein the instructions 124 to terminate the second data path 422 comprise instructions 124 to terminate the second data path 422 responsive to determining when the designated user input has not been detected within the predetermined amount of time, and wherein the instructions 124 to reestablish the first data path 406 with the second ECD 302, comprises instructions 124 to reestablish the first data path 406 responsive to termination the second data path 422.

24. The non-transitory computer readable medium of example 23, wherein the instructions 124 to render 816, 1116 the indication to prompt the user to enter the designated user input within the predetermined amount of time comprise instructions 124 to display a prompt on a display 130 of the first ECD 301.

25. The non-transitory computer readable medium of example 23, wherein the instructions 124 to render 816, 1116 the indication to prompt the user to enter the designated user input within the predetermined amount of time comprise instructions 124 to render a voice message 505, 605.

26. The non-transitory computer readable medium of example 23, wherein the instructions 124 to render 816, 1116 the indication to prompt the user to enter the designated user input within the predetermined amount of time comprise instructions 124 to emit one or more audio tones.

27. The non-transitory computer readable medium of example 22, wherein the instructions 124 further comprise instructions 124 to: transmit a control signal to the second ECD 302 operable to cause the second ECD 302 to rendering, at the first ECD 301, an indication that the second data path 422 will be terminated, and that the first data path 406 will be reestablished, absent a designated user action.

28. A method of operating an electronic communications device (ECD) 100, comprising: receiving a first data stream 308 at a first ECD 301 from a second ECD 302; detecting, at the first ECD 301 that the first data stream 308 from the second ECD 302 has been ceased being received; rendering, by the first ECD 301, an indication that the first ECD 301 will transmit a data path 316 initiation signal to the second ECD 302; receiving, at the first ECD 301, an acknowledgement signal from the second ECD 302; establishing, by the first ECD 301, a data path to the second ECD 302; and receiving a second data stream 308 at the first ECD 301 through the data path to the second ECD 302.

29. A method of recovering a data stream 308 in an electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; establishing, at the first ECD 301, a second channel 316 with a third ECD 303; pausing, at the first ECD 301, rendering of the first data, responsive to establishing the second channel 316 with the third ECD 303; receiving, at the first ECD 301, a second data stream 308 from the third ECD 303 over the second channel 316; rendering, at the first ECD 301, second data corresponding to the second data stream 308, using the one or more first output devices of the first ECD 301; rendering 816, 1116 a prompt at the first ECD 301, responsive to rendering the second data; detecting, at the first ECD 301, a first user input corresponding to the prompt; ceasing, at the first ECD 301, rendering of the second data, responsive to the detecting; and resuming, at the first ECD 301, rendering of the first data corresponding to the first data stream 308.

30. A method of recovering a data stream 308 in an electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; rendering 816, 1116 a prompt at the first ECD 301, responsive to rendering the second data; detecting, at the first ECD 301, a first user input corresponding to the prompt; ceasing, at the first ECD 301, rendering of the second data, responsive to the detecting; and resuming, at the first ECD 301, rendering of the first data corresponding to the first data stream 308.

31. A method of recovering a data stream 308 in electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; establishing, at the first ECD 301, a second channel 316 with a third ECD 303; pausing, at the first ECD 301, rendering of the first data, responsive to establishing the second channel 316 with the third ECD 303; receiving, at the first ECD 301, a second data stream 308 from the third ECD 303 over the second channel 316; rendering, at the first ECD 301, second data corresponding to the second data stream 308, using the one or more first output devices of the first ECD 301; determining, at the first ECD 301, that the first data stream 308 is currently being received from the second ECD 302 over the first channel 316; rendering 816, 1116 a prompt at the first ECD 301, responsive to the determining that the first data stream 308 is currently being received from the second ECD 302 over the first channel 316; determining, at the first ECD 301, that a user input corresponding to the prompt has not been detected within a predetermined length of time since rendering the prompt; ceasing, at the first ECD 301, rendering of the second data, responsive to determining that the user input corresponding to the prompt has not been detected within the predetermined length of time since rendering the prompt; and resuming, at the first ECD 301, rendering of the first data corresponding to the first data stream 308.

32. A method of recovering a data stream 308 in electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; determining, at the first ECD 301, that the first data stream 308 is currently being received from the second ECD 302 over the first channel 316; rendering 816, 1116 a prompt at the first ECD 301, responsive to determining that the first data stream 308 is currently being received from the second ECD 302 over the first channel 316; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

33. A method of recovering a data stream 308 in electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; establishing, at the first ECD 301, a second channel 316 with a third ECD 303; pausing, at the first ECD 301, rendering of the first data, responsive to establishing the second channel 316 with the third ECD 303; receiving, at the first ECD 301, a second data stream 308 from the third ECD 303 over the second channel 316; rendering, at the first ECD 301, second data corresponding to the second data stream 308, using the one or more first output devices of the first ECD 301; determining, at the first ECD 301, that the first data stream 308 is currently being received from the second ECD 302 over the first channel 316; rendering 816, 1116 a prompt at the first ECD 301, responsive to the determining; detecting, at the first ECD 301, a first user input corresponding to the prompt; ceasing, at the first ECD 301, rendering of the second data, responsive to the detecting; and resuming, at the first ECD 301, rendering of the first data corresponding to the first data stream 308.

34. A method of recovering a data stream 308 in electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; determining, at the first ECD 301, that the first data stream 308 is currently being received from the second ECD 302 over the first channel 316; rendering 816, 1116 a prompt at the first ECD 301, responsive to the determining; detecting, at the first ECD 301, a first user input corresponding to the prompt; ceasing, at the first ECD 301, rendering of the second data, responsive to the detecting; and resuming, at the first ECD 301, rendering of the first data corresponding to the first data stream 308.

35. A method of recovering a data stream 308 in electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from a third ECD 303; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; rendering 816, 1116 a prompt at the first ECD 301, responsive to rendering the second data corresponding to the second data stream 308; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

36. The method of example 35, wherein receiving the second data stream 308 from the third ECD 303 comprises establishing, at the first ECD 301, a second channel 316 with the third ECD 303.

37. A method of recovering a data stream 308 in electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; rendering 816, 1116 a prompt at the first ECD 301, responsive to rendering the second data corresponding to the second data stream 308; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

38. A method of recovering a data stream 308 in electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; establishing, at the first ECD 301, a second channel 316 with a third ECD 303; pausing, at the first ECD 301, rendering of the first data, responsive to establishing the second channel 316; receiving, at the first ECD 301, a second data stream 308 from the third ECD 303 over the second channel 316; rendering, at the first ECD 301, second data corresponding to the second data stream 308, using the one or more first output devices of the first ECD 301; rendering 816, 1116 a prompt at the first ECD 301; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

39. A method of recovering a data stream 308 in electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; rendering 816, 1116 a prompt at the first ECD 301, responsive to rendering the second data corresponding to the second data stream 308; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

40. A method of recovering a data stream 308 in electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; establishing, at the first ECD 301, a second channel 316 with a third ECD 303; pausing, at the first ECD 301, rendering of the first data, responsive to establishing the second channel 316 with the third ECD 303; receiving, at the first ECD 301, a second data stream 308 from the third ECD 303 over the second channel 316; rendering, at the first ECD 301, second data corresponding to the second data stream 308, using the one or more first output devices of the first ECD 301; rendering 816, 1116 a prompt at the first ECD 301, responsive to rendering the second data corresponding to the second data stream 308; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

41. A method of recovering a data stream 308 in electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; rendering 816, 1116 a prompt at the first ECD 301, responsive to rendering the second data corresponding to the second data stream 308; determining, at the first ECD 301, that a user input corresponding to the prompt has not been detected within a predetermined length of time since rendering 816, 1116 the prompt; ceasing, at the first ECD 301, rendering of the second data, responsive to determining that the user input corresponding to the prompt has not been detected within the predetermined length of time since rendering 816, 1116 the prompt; and resuming, at the first ECD 301, rendering of the first data corresponding to the first data stream 308.

42. A method of recovering a data stream 308 in electronic communications device (ECD) 100, comprising: establishing, at a first ECD 301, a first channel 316 with a second ECD 302; receiving, at the first ECD 301, a first data stream 308 from the second ECD 302 over the first channel 316; rendering, at the first ECD 301, first data corresponding to the first data stream 308, using one or more first output devices of the first ECD 301; establishing, at the first ECD 301, a second channel 316 with a third ECD 303; pausing, at the first ECD 301, rendering of the first data, responsive to establishing the second channel 316; receiving, at the first ECD 301, a second data stream 308 from the third ECD 303 over the second channel 316; rendering, at the first ECD 301, second data corresponding to the second data stream 308, using the one or more first output devices of the first ECD 301; rendering 816, 1116 a prompt at the first ECD 301; detecting, at the first ECD 301, a user input corresponding to the prompt; ceasing, at the first ECD 301, rendering of the second data, responsive to detecting the user input corresponding to the prompt; and resuming, at the first ECD 301, rendering of the first data corresponding to the first data stream 308.

43. A method of recovering a data stream 308 in electronic communications device (ECD) 100, comprising: establishing, at a first ECD 301, a first channel 316 with a second ECD 302; establishing, at the first ECD 301, a second channel 316 with a third ECD 303; receiving, at the first ECD 301, a first data stream 308 from the second ECD 302 over the first channel 316; rendering, at the first ECD 301, first data corresponding to the first data stream 308, using one or more first output devices of the first ECD 301; receiving, at the first ECD 301, a second data stream 308 from the third ECD 303 over the second channel 316; pausing, at the first ECD 301, rendering of the first data, responsive to receiving the second data stream 308 from the third ECD 303; rendering, at the first ECD 301, second data corresponding to the second data stream 308, using the one or more first output devices of the first ECD 301; rendering 816, 1116 a prompt at the first ECD 301, responsive to rendering the second data corresponding to the second data stream 308; detecting, at the first ECD 301, a user input corresponding to the prompt; ceasing, at the first ECD 301, rendering of the second data, responsive to detecting the user input corresponding to the prompt; and resuming, at the first ECD 301, rendering of the first data corresponding to the first data stream 308.

The various examples within this disclosure are provided by way of illustration and should not be construed to limit the scope of the disclosure. Various modifications and changes can be made to the principles and examples described herein without departing from the scope of the disclosure and without departing from the claims which follow.

1. A method of recovering a data path in an electronic communications device, comprising:
establishing, at a first electronic communications device, a first channel connection with a second electronic communications device;
receiving, at the first electronic communications device, a first data stream over the first channel connection from the second electronic communications device;
rendering, at the first electronic communications device, first data corresponding to the first data stream;
establishing, at the first electronic communications device, a second channel connection with a third electronic communications device;
pausing, at the first electronic communications device, the rendering of the first data, responsive to establishing the second channel connection;
receiving, at the first electronic communications device, a second data stream over the second channel connection from the third electronic communications device;
rendering, at the first electronic communications device, second data corresponding to the second data stream;
rendering a prompt at the first electronic communications device;
detecting, at the first electronic communications device, a user input corresponding to the prompt;
ceasing, at the first electronic communications device, the rendering of the second data, responsive to detecting the user input corresponding to the prompt; and
resuming, at the first electronic communications device, the rendering of the first data corresponding to the first data stream.

2. The method of claim 1, further comprising:
transmitting, by the first electronic communications device, a channel-initiation signal to the third electronic communications device; and
receiving, at the first electronic communications device, a channel-acceptance signal from the third electronic communications device,
wherein establishing, at the first electronic communications device, the second channel connection with the third electronic communications device comprises establishing the second channel connection with the third electronic communications device responsive to receiving the channel-acceptance signal at the first electronic communications device from the third electronic communications device.

3. The method of claim 1, further comprising:
receiving, at the first electronic communications device, a channel-initiation signal from the third electronic communications device; and
transmitting, by the first electronic communications device, a channel-acceptance signal to the third electronic communications device,
wherein establishing, at the first electronic communications device, the second channel connection with the third electronic communications device comprises establishing the second channel connection with the third electronic communications device responsive to receiving the channel-initiation signal from the third electronic communications device.

4. The method of claim 1, further comprising:
capturing, at the first electronic communications device, audio-visual data using one or more capture devices of the first electronic communications device;
transmitting, by the first electronic communications device, a third data stream to the second electronic communications device, the third data stream corresponding to the audio-visual data;
pausing, at the first electronic communications device, the transmitting of the third data stream to the second electronic communications device, responsive to establishing the second channel connection; and
resuming, by the first electronic communications device, the transmitting of the third data stream to the second electronic communications device, responsive to detecting the user input corresponding to the prompt.

5. The method of claim 4, wherein:
pausing, at the first electronic communications device, the transmitting of the third data stream to the second electronic communications device, comprises transmitting a fourth data stream to the third electronic communications device, the fourth data stream corresponding to the audio-visual data; and
resuming, by the first electronic communications device, the transmitting of the third data stream to the second electronic communications device comprises ceasing the transmitting of the fourth data stream to the third electronic communications device.

6. The method of claim 4, wherein capturing the audio-visual data using one or more capture devices of the first electronic communications device comprises:
capturing audio data using a microphone of the first electronic communications device; and
capturing video data using a camera of the first electronic communications device.

7-20. (canceled)
